(19) United States
(12) Patent Application Publication
(10) Pub. No.: US 2026/0333345 A1
(43) Pub. Date: Oct. 22, 2026

(54) UTO-UCI DETERMINATION WITH CONSIDERATION OF MEASUREMENT GAP SKIPPING

(71) Applicant: Apple Inc., Cupertino, CA (US)

(72) Inventors: Ping-Heng Kuo, London (GB); Naveen Kumar R. PALLE VENKATA, San Diego, CA (US); Qiming LI, Beijing (CN); Ralf Rossbach, Munich (DE); Weidong Yang, San Diego, CA (US)

(21) Appl. No.: 19/466,925

(22) Filed: Feb. 2, 2026

Related U.S. Application Data
(60) Provisional application No. 63/752,318, filed on Jan. 31, 2025.

(51) Int. Cl. H04W 72/1268; H04W 24/10; H04W 72/21; H04W 72/231

(52) U.S. Cl. CPC H04W 72/1268; H04W 24/10; H04W 72/21; H04W 72/231

(57) ABSTRACT

A method for wireless communication, the method comprising: receiving information indicating configured grant (CG) occasions for communication of information; selecting a set of one or more of the CG occasions for communicating information; determining that a CG occasion of the set of one or more CG occasions overlaps with a scheduled measurement occasion; determining whether the scheduled measurement occasion is eligible to be skipped; when the scheduled measurement occasion is eligible to be skipped, sending an indication, in unused transmission occasion uplink control information (UTO-UCI), that the CG occasion is valid for use by a user equipment (UE); and when the scheduled measurement occasion is not eligible to be skipped, sending an indication, in the UTO-UCI, that the CG occasion is not valid for use by the UE.

### CLAIM OF PRIORITY

This application claims priority to and the benefit of U.S. Provisional Patent Application No. 63/752,318, filed Jan. 31, 2025, the entire contents of which are incorporated herein by reference.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In an aspect, a method for wireless communication comprises receiving information indicating configured grant (CG) occasions for communication of information; selecting a set of one or more of the CG occasions for communicating information; determining that a CG occasion of the set of one or more CG occasions overlaps with a scheduled measurement occasion; determining whether the scheduled measurement occasion is eligible to be skipped; and when the scheduled measurement occasion is eligible to be skipped, sending an indication, in unused transmission occasion uplink control information (UTO-UCI), that the CG occasion is valid for use by a user equipment (UE); and when the scheduled measurement occasion is not eligible to be skipped, sending an indication, in the UTO-UCI, that the CG occasion is not valid for use by the UE.

In some implementations, the method includes determining that the scheduled measurement occasion is not being skipped; and sending an indication that the CG occasion is available for use by another UE that is different than the UE.

In some implementations, sending the indication in UTO-UCI that the CG occasion is valid for use by the UE comprises excluding the CG occasion from consideration, during generation of the UTO-UCI, as being an unused resource.

In some implementations, sending the indication in UTO-UCI that the CG occasion is invalid for use by the UE comprises indicating, in a bitmap of the UTO-UCI, that the CG occasion is not being used by the UE.

In some implementations, the method includes determining that the scheduled measurement occasion is not being skipped; and sending updated UTO-UCI that explicitly indicates that the CG occasion the CG occasion is available for use by a network.

In some implementations, the UTO-UCI that indicates that the CG occasion is valid for use by the UE explicitly indicates that the CG occasion the CG occasion is not available for use by a network, and wherein the method further comprises determining that the scheduled measurement occasion is not being skipped; and sending an updated UTO-UCI that indicates that the CG occasion is available for use by the network.

In some implementations, the method includes determining that the scheduled measurement occasion is being skipped; and scheduling a physical uplink shared channel (PUSCH) transmission using the CG occasion of the set of one or more CG occasions overlaps with a scheduled measurement occasion.

In some implementations, the method includes determining that the scheduled measurement occasion is being skipped; and sending the indication in UTO-UCI that the CG occasion is valid for use by the UE by explicitly indicating in the UTO-UCI that the UE is using the CG occasion for a PUSCH transmission.

In some implementations, sending the indication in UTO-UCI that the CG occasion is valid for use by the UE comprises indicating, in a bitmap of the UTO-UCI, that the CG occasion is being used by the UE.

In some implementations, the scheduled measurement occasion comprises a measurement gap.

In some implementations, the scheduled measurement occasion comprises a synchronization signal (SS) or physical broadcast channel (PBCH) block measurement timing configuration (SMTC) window.

In some implementations, determining whether the scheduled measurement occasion is eligible to be skipped comprises determining that downlink control information (DCI) indicating that the scheduled measurement occasion is being skipped is receivable prior to the CG occasion.

In some implementations, selecting the set of one or more of the CG occasions for communicating information comprises determining an amount of buffered data that can be transmitted on available CG occasions for the UE.

In an aspect, a method for wireless communication includes receiving information indicating configured grant (CG) occasions for communication of information; selecting a set of one or more of the CG occasions for communicating information; determining that a CG occasion of the set of one or more CG occasions overlaps with a scheduled measurement occasion; determining that the scheduled measurement occasion is eligible to be skipped; sending an indication, in unused transmission occasion uplink control information (UTO-UCI), that the CG occasion is being used by a user equipment (UE); receiving an indication that the scheduled measurement occasion is not being skipped; and sending updated UTO-UCI that indicates that the CG occasion is not being used by the UE.

In some implementations, sending the indication in the UTO-UCI that the that the CG occasion is being used by the UE comprises indicating, in a bitmap of the UTO-UCI, that the CG occasion is being used by the UE. In some implementations, sending the updated UTO-UCI comprises indicating, in a bitmap of the UTO-UCI, that the CG occasion is not being used by the UE. In some implementations, the scheduled measurement occasion comprises a synchronization signal (SS) or physical broadcast channel (PBCH) block measurement timing configuration (SMTC) window. In some implementations, the scheduled measurement occasion comprises a measurement gap.

In an aspect, a non-transitory computer storage medium encoded with instructions that, when executed by one or more computers, cause the one or more computers to perform the method of any preceding method.

In an aspect, a system comprising one or more processors and one or more storage devices on which are stored instructions that are operable, when executed by the one or more processors, to cause the one or more processors to perform the method of any preceding method.

In an aspect, an apparatus comprising one or more baseband processors configured to perform the method of any preceding method.

In an aspect, one or more processors comprising circuitry that executes instructions to cause a user equipment (UE) to perform the method of any preceding method.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIG. 2 illustrates a timing diagram showing configured grant (CG) occasions and unused CG occasions for a UE.

FIG. 3 illustrates timing diagrams showing CG occasions and unused CG occasions for a UE.

FIG. 4 illustrates a method for UTO-UCI determination with consideration of measurement gap skipping.

FIG. 5 illustrates a method for UTO-UCI determination with consideration of measurement gap skipping.

FIG. 6 illustrates a method for UTO-UCI determination with consideration of measurement gap skipping.

FIG. 7 illustrates a user equipment (UE), according to some implementations.

FIG. 8 illustrates an access node, according to some implementations.

### DETAILED DESCRIPTION

In wireless communications, a user equipment (UE) is configured to indicate uplink (UL) resources for use or for non-use by the UE in a subsequent transmission. Systems and methods described herein enable a UE to determine uplink shared channel (UL-SCH) resource availability more accurately. The UE is configured to determine unused transmission occasion(s) to indicate in uplink control information (UCI) (UTO-UCI) of the UE when one or more measurement gaps or synchronization signal (SS) or physical broadcast channel (PBCH) block measurement timing configuration (SMTC) windows can be skipped. The systems and methods described herein further enable the UE to still use configured grant (CG) occasions that overlap with a measurement gap or SMTC window when that measurement gap or SMTC window can be skipped.

The network can provide measurement gap and SMTC window information to the UE in radio resource control (RRC) information when indicated CG occasions to the UE. The CG is a mechanism that enables the UE and network to perform UL scheduling by RRC messages and scheduling physical uplink shared channel (PUSCH) transmissions without downlink control information (DCI).

A measurement gap configuration information element (IE) (e.g., MeasGapConfig) configures the UE with either per-UE measurement gaps or per frequency range measurement gaps. For example, the network can specify per-UE gap or frequency range 1 (FR1) gap in new radio (NR) standalone operation with a single carrier (such as NR carrier aggregation (CA), NR dual connectivity (NR-DC)), or for operation in evolved universal mobile telecommunications service (UMTS) terrestrial radio access (NR-E-UTRA) dual connectivity (NE-DC) operation. The network can configure the UE with frequency range 2 (FR2) gap information for various configurations including NR standalone operation (with single carrier, NR CA and NR-DC), EN-DC operation, or NE-DC operation.

The network provides a timing of neighbor cell synchronization signal blocks (SSBs) using SMTC information. The measurement gap and SMTC duration are configured to allow the UE to identify and measure the SSBs within the SMTC window. The SMTC duration is long enough to allow the UE to measure all SSBs that are being transmitted.

As indicated above, the UE can indicate to the network, by UTO-UCI, which of the subsequent CG occasions, indicated by the network, will not be used by the UE. The UTO-UCI includes a bitmap in which each bit represents a subsequent CG occasion following the physical uplink shared channel (PUSCH) which multiplexes the UCI. The UTO-UCI enables the network to improve resource efficiency, as the network may re-allocate the unused resource to other UEs. When UTO-UCI is enabled for a CG configuration, the UE multiplexes the UCI into every PUSCH occasion of the CG configuration that is to be transmitted. A CG occasion that has been indicated as “unused” is not used by the UE. The state of the CG occasion is not subsequently updated to a “used” state.

The UE may indicate, by UTO-UCI to the network, that some CG occasions are to be unused by the UE because one or more measurement gaps overlap with those CG occasions. However, the network may later send downlink control information (DCI) that indicates to the UE that the UE should skip those measurement gaps. In this situation, UE no longer is performing the measurements and no longer requires a measurement gap. The UE may now use the (previously) overlapping CG occasions, except that the UE has already indicated to the network that the UE will not use the overlapping CG occasions. While it is possible that the network may have reallocated those CG occasions, in cases in which the network has not reallocated the unused CG occasions, the resources are wasted. The UE may experience relatively higher latency (relative to use of the unused CG occasion) because the UE waits until the next available CG grant occasion that was not indicated as unused in the UTO-UCI.

To avoid wasting CG occasions, the UE may consider the UL-SCH resource availability differently when using UTO-UCI and let the network know that the CG occasions are unused. The UE can still use CG occasions that overlap with a measurement gap or SMTC window when that measurement gap or SMTC window can be skipped. When there is potential that the measurement gap can be skipped, the UE may wait until the network confirms that the measurement gap will not be skipped before the UE indicates to the network that the CG occasion will be unused for that UE. The UE may consider the CG occasions as being available in the UTO-UCI until the secondary confirmation occurs.

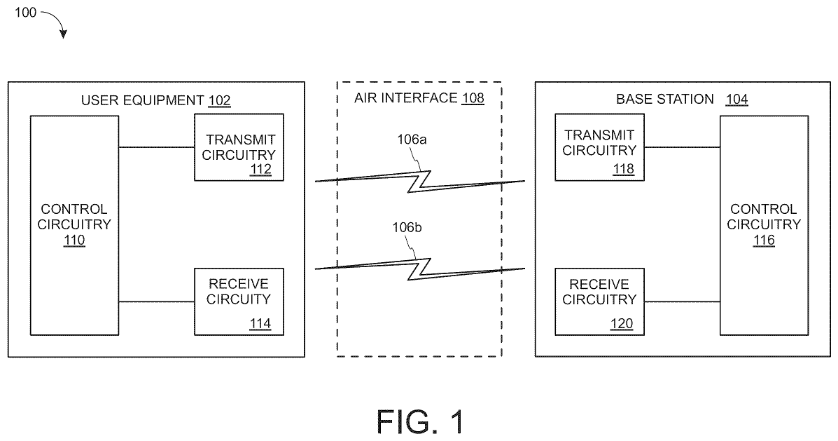

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104. The UE 102 can generate the UTO-UCI described herein responsive to RRC communication. The UE 102, as described herein, can indicate to the base station 104 that corresponding CG occasions are to be used by the UE 102, even if a measurement gap is scheduled for the UE, until the network confirms to the UE that the measurement gap is not to be skipped.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE.

The transmit circuitry 112 can perform various operations described in this specification. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

In some implementations, the transmit circuity 112 and receive circuitry 114 of the UE 102 can perform the following operations. The receive circuitry 114 may receive information indicating configured grant (CG) occasions for communication of information. One or more processors of the UE 102 may select a set of one or more of the CG occasions for communicating information. The one or more processors of the UE 102 may determine that a CG occasion of the set of one or more CG occasions overlaps with a scheduled measurement occasion. The one or more processors of the UE 102 may determine whether the scheduled measurement occasion is eligible to be skipped. When the scheduled measurement occasion is eligible to be skipped, the transmit circuitry 112 of the UE 102 may send an indication, in unused transmission occasion uplink control information (UTO-UCI), that the CG occasion is valid for use by a user equipment (UE). When the scheduled measurement occasion is not eligible to be skipped, the transmit circuitry 112 of the UE 102 may send an indication, in the UTO-UCI, that the CG occasion is not valid for use by the UE.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

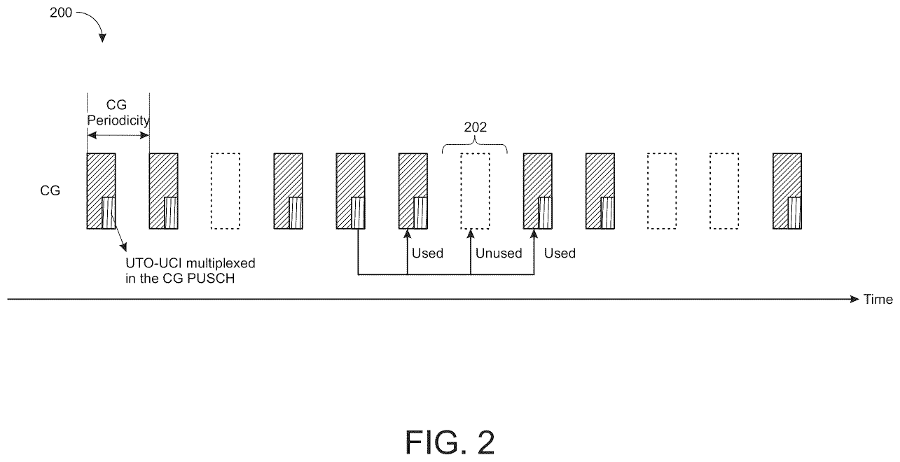

FIG. 2 illustrates a timing diagram 200 showing configured grant (CG) occasions and unused CG occasions for a UE (e.g., UE 102 of FIG. 1). The UE receives the configuration of the measurement gaps, and the SMTC windows from the network and the configured grant (CG) information specifying periodic resources available to the UE for UL transmission. The UE determines which resources of the CG are to be used by the UE for UL transmissions and which resources, such as resource 202, are not being used by the UE for UL transmissions. For example, for a CG that is configured with UTO-UCI, the medium access control (MAC) entity (of the UE) determines if a configured uplink grant which is within the subsequent number of bits in the UTO-UCI valid occasions of the associated CG configuration is going to be used for PUSCH transmissions.

The MAC entity considers at least the amount of buffered data that can be transmitted on the available occasions of the CG and other available UL-SCH resources. Upon this determination, the MAC entity (of the UE) sends an indication to lower layers for use the procedure reporting UTO-UCI. The indication indicates to the network how many CG occasions the UE requires for PUSCH transmissions. The MAC entity of the UE may indicate that the other CG occasions are unused. The UE can indicate the unused transmission occasions (UTOs) to the network in the UCI to allow the network to use (reallocate) these resources elsewhere. Specifically, the UE can indicate instances of periodic resources in the CG that are available to the UE but that the UE does not intend to use in an UL transmission. The network can then reschedule or reallocate those instances of periodic resources to another use, such as for use by another UE. The network can optimize bandwidth overall in the network by such rescheduling.

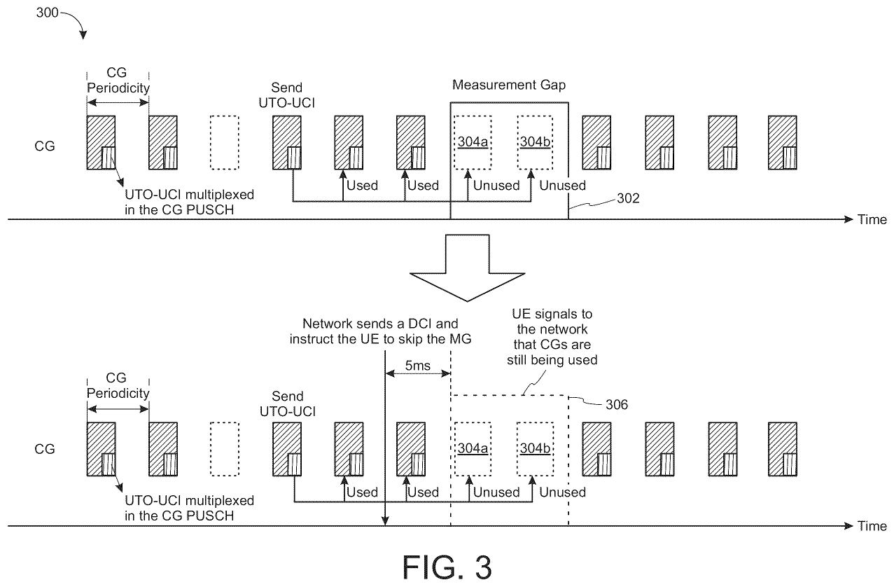

FIG. 3 illustrates timing diagrams 300 showing an enhanced UTO-UCI to consider measurement gap skipping. When a measurement gap is scheduled, the UE can include these resources in the indicated unused CG occasions. For example, the UE (e.g., UE 102), determines that a measurement gap (or SMTC window) 302 is scheduled that overlaps with one or more CG occasions, 304a, 304b. The UE would typically indicate to the network, though UTO-UCI, that the CG occasions 304a, 304b are unused through a bitmap, as previously discussed. The network can reallocate these CG occasions for use by other UEs.

For enhanced UTO-UCI that considers measurement gap skipping, the UE confirms whether a measurement gap 302 is skippable when performing UTO-UCI before indicating to the network that the CG occasions are to be used. Because there is a short amount of time (~5 milliseconds) between when the UE receives the network indication that the measurement gap is being skipped and the overlapping CG occasion, the UE does not always wait until after the UTO-UCI process to indicate that overlapping CG occasions 304a, 304b are unused. Instead, the UE dynamically confirms whether the measurement gap 302 is skippable. When the measurement gap 306 is skippable, the UE indicates in the UTO-UCI that the overlapping CG occasions 304a, 304b as available until the network confirms that the measurement gap 306 is not being skipped.

In some implementations, the feature of measurement gap skipping may not be available or may not be configured. When that is the case, the UE indicates in the UTO-UCI that the overlapping resources 304a, 304b are not available. When the network indicates that the measurement gap 306 is being skipped, the UE can use the CG resources 304a, 304b and they are not wasted. For example, when the network indicates to the UE that the measurement gap 306 is to be skipped, the UE can use the overlapping CG occasions 304a, 304b because the UE did not indicate in the UTO-UCI that the CG occasions were unused. Rather, the UE considers the CG occasions 304a, 304b to be valid and available during UTO-UCI derivation (if other criteria for the availability are also met), until it is confirmed that the measurement gap will not be skipped).

The UE configures the UTO-UCI by considering the amount of buffered data that can be transmitted on the available occasions of the associated configured grant and other available UL-SCH resources. The UE identifies which CG occasion and UL-SCH resource are “available” or “valid”. The UE can consider any CG occasion or UL-SCH resource that overlaps with a measurement gap or SMTC window. The UE determines whether the overlapping measurement gap or SMTC window may be skipped. If not, the UE considers the CG occasion and/or UL-SCH as unavailable. If the overlapping measurement gap or SMTC window may be skipped, the UE considers the CG occasion and/or UL-SCH as available/valid, if other criteria of availability are also met. The UE then confirms whether measurement gap skipping or SMTC window skipping (or not) is to be performed.

In an aspect, for a configured grant configured with UTO-UCI, a MAC entity determines if a configured uplink grant which is within the subsequent nrofBitsInUTO-UCI valid occasions of its associated configured grant configuration is going to be used for PUSCH transmission by considering at least the amount of buffered data that can be transmitted on the available occasions of the associated configured grant and other available UL-SCH resources. If measurement gap skipping is enabled, the CG occasions and other UL-SCH resources that overlap with a measurement gap may be considered as available, until confirming that the measurement gap is not to be skipped. Upon this determination, the MAC entity sends an indication to lower layers, for use in the procedure for reporting UTO-UCI.

In some implementations, the UE can explicitly indicate in the UTO-UCI that CG occasions 304a, 304b are unused when the CG occasions are within a measurement gap 302 that is not skippable. For example, the UE determines during UTO-UCI if a CG occasion to be included in the UTO-UCI bitmap overlaps with a measurement gap or a SMTC window. The UE checks if the overlapping measurement gap or the SMTC window could be potentially skipped or deactivated dynamically. In some implementations, the overlapping measurement gap or SMTC window cannot be skipped (e.g. the feature of measurement gap skipping is not configured). The UE determines that the CG occasion as “unused” and indicate this in the corresponding UTO-UCI bitmap. In some implementations, when the overlapping measurement gap or SMTC window can potentially be skipped (e.g. the network may send a DCI to skip the measurement gap later on), the UE determines the CG occasion as “used” and indicate this explicitly in the corresponding UTO-UCI bitmap. The UE may update it to be “unused” subsequently, when the UE confirms that the measurement gap will not be skipped. The measurement gap may be any type of measurement gap, including the positioning measurement gap. In this example, when the UE signals that a resource is “used,” it can revise this indication later to “unused.” There is no particular time constraint on this indication by the UE to the network with respect to the unused CG occasion. If the network has the opportunity to schedule the resource for another UE, the network can do so, or the resource can remain unused.

For a configured grant configured with UTO-UCI, the MAC entity determines if a configured uplink grant which is within the subsequent nrofBitsInUTO-UCI valid occasions of its associated configured grant configuration is going to be used for PUSCH transmission by considering at least the amount of buffered data that can be transmitted on the available occasions of the associated configured grant and other available UL-SCH resources. If measurement gap skipping is enabled, any CG occasions that overlaps with a measurement gap should be indicated as “used” in the UTO-UCI, until confirming that the measurement gap is not to be skipped. Upon this determination, the MAC entity sends an indication to lower layers, for use in the procedure for reporting UTO-UCI.

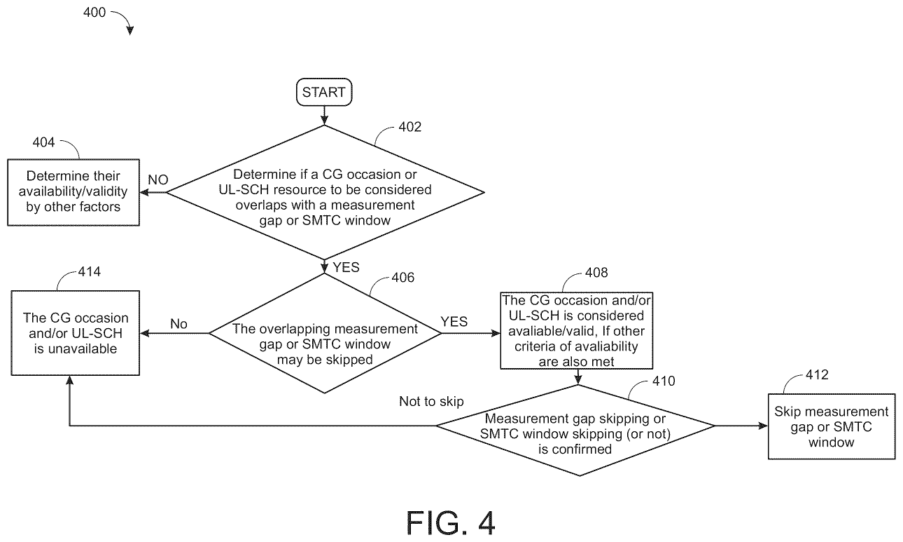

FIG. 4 illustrates a method 400 for UTO-UCI determination with consideration of measurement gap skipping. For clarity of presentation, the description that follows generally describes method 400 in the context of the other figures in this description. For example, method 400 can be performed by UE 102 of FIG. 1. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

The UE determine UTO-UCI by considering the amount of buffered data that can be transmitted on the available occasions of the associated configured grant and other available UL-SCH resources. The UE needs to first identify which CG occasion and UL-SCH resource are “available” or “valid”. The UE determines (402) if a CG occasion or UL-SCH resource to be considered overlaps with a measurement gap or SMTC window. If there are no overlapping measurement gaps or a SMTC windows, the UE determines the resource availability and/or validity by other factors, such as whether they are needed for PUSCH transmissions. If there are overlapping measurement gaps or SMTC windows, the UE determines (406) whether the overlapping measurement gap or SMTC window may be skipped. If the overlapping measurement gap or SMTC window cannot be skipped, the UE determines (414) that the CG occasions that overlap with the MG or SMTC window are invalid or unavailable for the UTO-UCI derivation. If the overlapping measurement gap or SMTC window can be skipped, the UE determines (408) that the CG occasions that overlap with the MG or the SMTC window are available or valid for the UTO-UCI derivation (if other typical availability criteria have also been met for those resources). The UE performs UTO-UCI derivation The UE confirms (410) whether measurement gap skipping is to occur based on signaling from the network. If the network indicates that the measurement gap is being skipped, the UE skips (412) the measurement gap and uses the CG resources.

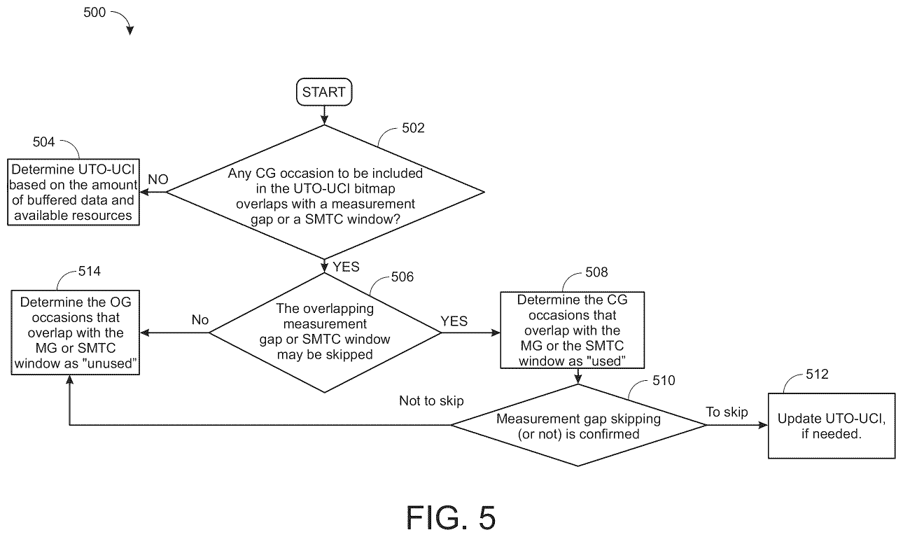

FIG. 5 illustrates a method 500 for UTO-UCI determination with consideration of measurement gap skipping. For clarity of presentation, the description that follows generally describes method 500 in the context of the other figures in this description. For example, method 500 can be performed by UE 102 of FIG. 1. It will be understood that method 500 can be performed, for example, by any suitable system, environment, software, hardware, or a combination of systems, environments, software, and hardware, as appropriate. In some implementations, various steps of method 500 can be run in parallel, in combination, in loops, or in any order.

The UE determines the UTO-UCI by considering the amount of buffered data that can be transmitted on the available occasions of the associated configured grant and other available UL-SCH resources. The UE determines (502) whether any CG occasion to be included in the UTO-UCI bitmap overlaps with a measurement gap or a SMTC window. If there are no overlapping measurement gaps or a SMTC windows, the UE derives or generates (504) the UTO-UCI based on the amount of buffered data and available resources. If there are overlapping measurement gaps or SMTC windows, the UE determines (506) whether the overlapping measurement gap or SMTC window may be skipped. If the overlapping measurement gap or SMTC window cannot be skipped, the UE determines (514) that the CG occasions that overlap with the MG or SMTC window are “unused”. The “unused” state of the overlapping CG occasions is explicitly signaled in the UTO-UCI. If the overlapping measurement gap or SMTC window can be skipped, the UE determines (508) that the CG occasions that overlap with the MG or the SMTC window are “used”. The “used” state of the overlapping CG occasions is explicitly signaled in the UTO-UCI. The UE confirms (510) whether measurement gap skipping is to occur based on signaling from the network. If the network indicates that the measurement gap is being skipped, the UE updates (512) the UTO-UCI to indicate that the CG occasions are now “unused” by the UE, as described in step 514.

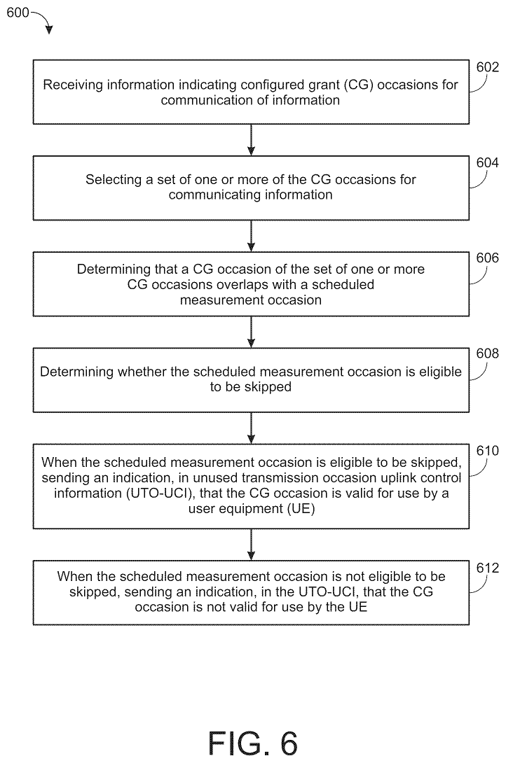

FIG. 6 illustrates a method 600 for UTO-UCI determination with consideration of measurement gap skipping. For clarity of presentation, the description that follows generally describes method 600 in the context of the other figures in this description. For example, method 600 can be performed by UE 102 of FIG. 1. It will be understood that method 600 can be performed, for example, by any suitable system, environment, software, hardware, or a combination of systems, environments, software, and hardware, as appropriate. In some implementations, various steps of method 600 can be run in parallel, in combination, in loops, or in any order.

The method 600 includes receiving (602) information indicating configured grant (CG) occasions for communication of information. The method 600 includes selecting (604) a set of one or more of the CG occasions for communicating information. The method 600 includes determining (606) that a CG occasion of the set of one or more CG occasions overlaps with a scheduled measurement occasion. The method 600 includes determining (608) whether the scheduled measurement occasion is eligible to be skipped. The method 600 includes, when the scheduled measurement occasion is eligible to be skipped, sending (610) an indication, in unused transmission occasion uplink control information (UTO-UCI), that the CG occasion is valid for use by a user equipment (UE). The method 600 includes, when the scheduled measurement occasion is not eligible to be skipped, sending (612) an indication, in the UTO-UCI, that the CG occasion is not valid for use by the UE.

In some implementations, the method 600 includes determining that the scheduled measurement occasion is not being skipped; and sending an indication that the CG occasion is available for use by another UE that is different than the UE.

In some implementations, sending the indication in UTO-UCI that the CG occasion is valid for use by the UE comprises excluding the CG occasion from consideration, during generation of the UTO-UCI, as being an unused resource.

In some implementations, sending the indication in UTO-UCI that the CG occasion is invalid for use by the UE comprises indicating, in a bitmap of the UTO-UCI, that the CG occasion is not being used by the UE.

In some implementations, the method 600 includes determining that the scheduled measurement occasion is not being skipped; and sending updated UTO-UCI that explicitly indicates that the CG occasion the CG occasion is available for use by a network.

In some implementations, the UTO-UCI that indicates that the CG occasion is valid for use by the UE explicitly indicates that the CG occasion the CG occasion is not available for use by a network, and wherein the method further comprises determining that the scheduled measurement occasion is not being skipped; and sending an updated UTO-UCI that indicates that the CG occasion is available for use by the network.

In some implementations, the method 600 includes determining that the scheduled measurement occasion is being skipped; and scheduling a physical uplink shared channel (PUSCH) transmission using the CG occasion of the set of one or more CG occasions overlaps with a scheduled measurement occasion.

In some implementations, the method 600 includes determining that the scheduled measurement occasion is being skipped; and sending the indication in UTO-UCI that the CG occasion is valid for use by the UE by explicitly indicating in the UTO-UCI that the UE is using the CG occasion for a PUSCH transmission.

In some implementations, sending the indication in UTO-UCI that the CG occasion is valid for use by the UE comprises indicating, in a bitmap of the UTO-UCI, that the CG occasion is being used by the UE.

In some implementations, the scheduled measurement occasion comprises a measurement gap.

In some implementations, the scheduled measurement occasion comprises a synchronization signal (SS) or physical broadcast channel (PBCH) block measurement timing configuration (SMTC) window.

In some implementations, determining whether the scheduled measurement occasion is eligible to be skipped comprises determining that downlink control information (DCI) indicating that the scheduled measurement occasion is being skipped is receivable prior to the CG occasion.

In some implementations, selecting the set of one or more of the CG occasions for communicating information comprises determining an amount of buffered data that can be transmitted on available CG occasions for the UE.

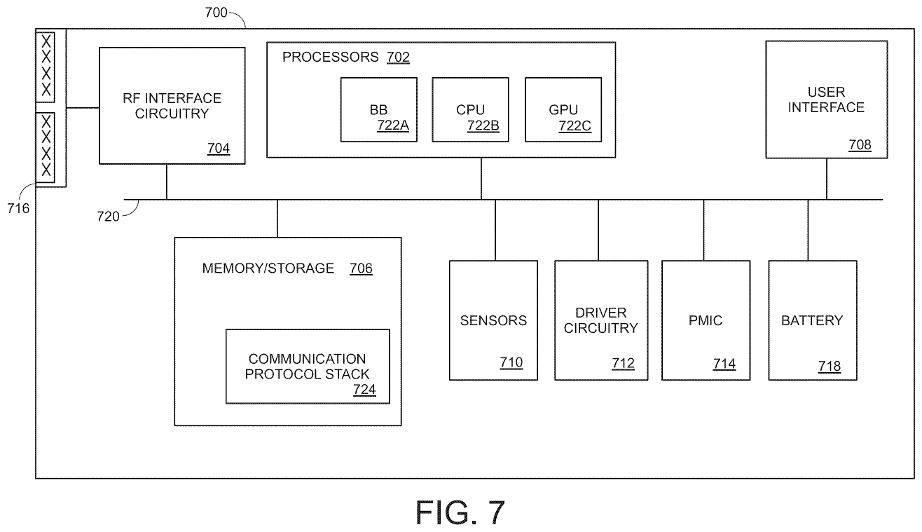

FIG. 7 illustrates a UE 700, according to some implementations. The UE 700 may be similar to and substantially interchangeable with UE 102 of FIG. 1. The UE 700 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 700 may include processors 702, RF interface circuitry 704, memory/storage 706, user interface 708, sensors 710, driver circuitry 712, power management integrated circuit (PMIC) 714, antenna structure 716, and battery 718. The components of the UE 700 may be implemented as integrated circuits (ICs), portions thereof, discrete electronic devices, or other modules, logic, hardware, software, firmware, or a combination thereof. The block diagram of FIG. 7 is intended to show a high-level view of some of the components of the UE 700. However, some of the components shown may be omitted, additional components may be present, and different arrangement of the components shown may occur in other implementations.

The components of the UE 700 may be coupled with various other components over one or more interconnects 720, which may represent any type of interface, input/output, bus (local, system, or expansion), transmission line, trace, optical connection, etc. that allows various circuit components (on common or different chips or chipsets) to interact with one another.

The processors 702 may include processor circuitry such as, for example, baseband processor circuitry (BB) 722A, central processor unit circuitry (CPU) 722B, and graphics processor unit circuitry (GPU) 722C. The processors 702 may include any type of circuitry or processor circuitry that executes or otherwise operates computer-executable instructions, such as program code, software modules, or functional processes from memory/storage 706 to cause the UE 700 to perform operations as described herein.

In some implementations, the baseband processor circuitry 722A may access a communication protocol stack 724 in the memory/storage 706 to communicate over a 3GPP compatible network. In general, the baseband processor circuitry 722A may access the communication protocol stack to perform user plane functions at a physical (PHY) layer, MAC layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 704. The baseband processor circuitry 722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The baseband processor circuitry 722A may be configured for receiving information indicating configured grant (CG) occasions for communication of information. The baseband processor circuitry 722A may be configured for selecting a set of one or more of the CG occasions for communicating information. The baseband processor circuitry 722A may be configured for determining that a CG occasion of the set of one or more CG occasions overlaps with a scheduled measurement occasion. The baseband processor circuitry 722A may be configured for determining whether the scheduled measurement occasion is eligible to be skipped. When the scheduled measurement occasion is eligible to be skipped, the baseband processor circuitry 722A may be configured for sending an indication, in unused transmission occasion uplink control information (UTO-UCI), that the CG occasion is valid for use by a user equipment (UE). When the scheduled measurement occasion is not eligible to be skipped, the baseband processor circuitry 722A may be configured for sending an indication, in the UTO-UCI, that the CG occasion is not valid for use by the UE.

The baseband processor circuitry 722A may be configured for receiving information indicating configured grant (CG) occasions for communication of information. The baseband processor circuitry 722A may be configured for selecting a set of one or more of the CG occasions for communicating information. The baseband processor circuitry 722A may be configured for determining that a CG occasion of the set of one or more CG occasions overlaps with a scheduled measurement occasion. The baseband processor circuitry 722A may be configured for determining that the scheduled measurement occasion is eligible to be skipped. The baseband processor circuitry 722A may be configured for sending an indication, in unused transmission occasion uplink control information (UTO-UCI), that the CG occasion is being used by a user equipment (UE). The baseband processor circuitry 722A may be configured for receiving an indication that the scheduled measurement occasion is not being skipped. The baseband processor circuitry 722A may be configured for sending updated UTO-UCI that indicates that the CG occasion is not being used by the UE.

The memory/storage 706 may include one or more non-transitory, computer-readable media that includes instructions (for example, communication protocol stack 724) that may be executed by one or more of the processors 702 to cause the UE 700 to perform various operations described herein. The memory/storage 706 include any type of volatile or non-volatile memory that may be distributed throughout the UE 700. In some implementations, some of the memory/storage 706 may be located on the processors 702 themselves (for example, L1 and L2 cache), while other memory/storage 706 is external to the processors 702 but accessible thereto via a memory interface. The memory/storage 706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 704 may include transceiver circuitry and radio frequency front module (RFEM) that allows the UE 700 to communicate with other devices over a radio access network. The RF interface circuitry 704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 716 and proceed to filter and amplify (with a low-noise amplifier) the signal. The signal may be provided to a receiver of the transceiver that downconverts the RF signal into a baseband signal that is provided to the baseband processor of the processors 702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 716. In various implementations, the RF interface circuitry 704 may be configured to transmit/receive signals in a manner compatible with NR access technologies.

The antenna 716 may include antenna elements to convert electrical signals into radio waves to travel through the air and to convert received radio waves into electrical signals. The antenna elements may be arranged into one or more antenna panels. The antenna 716 may have antenna panels that are omnidirectional, directional, or a combination thereof to enable beamforming and multiple input, multiple output communications. The antenna 716 may include microstrip antennas, printed antennas fabricated on the surface of one or more printed circuit boards, patch antennas, phased array antennas, etc. The antenna 716 may have one or more panels designed for specific frequency bands including bands in FR1 or FR2.

The user interface 708 includes various input/output (I/O) devices designed to enable user interaction with the UE 700. The user interface 708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 700.

The sensors 710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 712 may include software and hardware elements that operate to control particular devices that are embedded in the UE 700, attached to the UE 700, or otherwise communicatively coupled with the UE 700. The driver circuitry 712 may include individual drivers allowing other components to interact with or control various input/output (I/O) devices that may be present within, or connected to, the UE 700. For example, driver circuitry 712 may include a display driver to control and allow access to a display device, a touchscreen driver to control and allow access to a touchscreen interface, sensor drivers to obtain sensor readings of sensor circuitry 710 and control and allow access to sensor circuitry 710, drivers to obtain actuator positions of electro-mechanic components or control and allow access to the electro-mechanic components, a camera driver to control and allow access to an embedded image capture device, audio drivers to control and allow access to one or more audio devices.

The PMIC 714 may manage power provided to various components of the UE 700. In particular, with respect to the processors 702, the PMIC 714 may control power-source selection, voltage scaling, battery charging, or DC-to-DC conversion.

In some implementations, the PMIC 714 may control, or otherwise be part of, various power saving mechanisms of the UE 700. A battery 718 may power the UE 700, although in some examples the UE 700 may be mounted deployed in a fixed location and may have a power supply coupled to an electrical grid. The battery 718 may be a lithium ion battery, a metal-air battery, such as a zinc-air battery, an aluminum-air battery, a lithium-air battery, and the like. In some implementations, such as in vehicle-based applications, the battery 718 may be a typical lead-acid automotive battery.

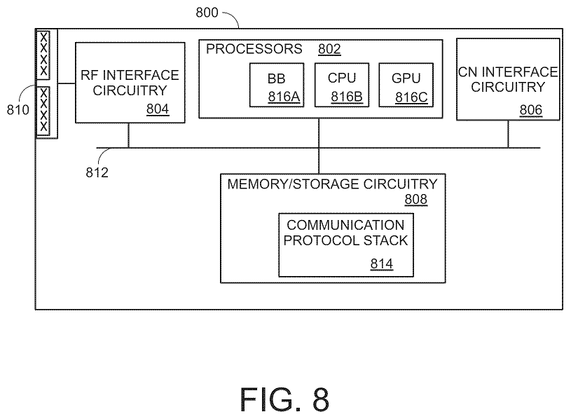

FIG. 8 illustrates an access node 800 (e.g., a base station or gNB), according to some implementations. The access node 800 may be similar to and substantially interchangeable with base station 104. The access node 800 may include processors 802, RF interface circuitry 804, core network (CN) interface circuitry 806, memory/storage circuitry 808, and antenna structure 810.

The components of the access node 800 may be coupled with various other components over one or more interconnects 812. The processors 802, RF interface circuitry 804, memory/storage circuitry 808 (including communication protocol stack 814), antenna structure 810, and interconnects 812 may be similar to like-named elements shown and described with respect to FIG. 7. For example, the processors 802 may include processor circuitry such as, for example, baseband processor circuitry (BB) 816A, central processor unit circuitry (CPU) 816B, and graphics processor unit circuitry (GPU) 816C.

The processors 802 may be configured for sending information indicating configured grant (CG) occasions for communication of information. The processors 802 may be configured to receive an indication, in unused transmission occasion uplink control information (UTO-UCI), that the CG occasion is valid for use by a user equipment (UE). When the scheduled measurement occasion is not eligible to be skipped, the processors 802 may be configured to receive an indication may be configured for sending an indication, in the UTO-UCI, that the CG occasion is not valid for use by the UE. When the CG occasion is not valid for use by the UE, the processors 802 may be configured to reallocate the CG occasion to a different UE.

The baseband processor circuitry 722A may be configured for receiving information indicating configured grant (CG) occasions for communication of information. The baseband processor circuitry 722A may be configured for selecting a set of one or more of the CG occasions for communicating information. The baseband processor circuitry 722A may be configured for determining that a CG occasion of the set of one or more CG occasions overlaps with a scheduled measurement occasion. The baseband processor circuitry 722A may be configured for determining that the scheduled measurement occasion is eligible to be skipped. The baseband processor circuitry 722A may be configured for sending an indication, in unused transmission occasion uplink control information (UTO-UCI), that the CG occasion is being used by a user equipment (UE). The baseband processor circuitry 722A may be configured for receiving an indication that the scheduled measurement occasion is not being skipped. The baseband processor circuitry 722A may be configured for sending updated UTO-UCI that indicates that the CG occasion is not being used by the UE.

The CN interface circuitry 806 may provide connectivity to a core network, for example, a 5th Generation Core network (5GC) using a 5GC-compatible network interface protocol such as carrier Ethernet protocols, or some other suitable protocol. Network connectivity may be provided to/from the access node 800 via a fiber optic or wireless backhaul. The CN interface circuitry 806 may include one or more dedicated processors or FPGAs to communicate using one or more of the aforementioned protocols. In some implementations, the CN interface circuitry 806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 800 that operates in an NR or 5G system (for example, a gNB), and the term “E-UTRAN node” or the like may refer to an access node 800 that operates in an LTE or 4G system (e.g., an eNB). According to various implementations, the access node 800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 800 may be implemented as one or more software entities running on server computers as part of a virtual network, which may be referred to as a CRAN and/or a virtual baseband unit pool (vBBUP). In V2X scenarios, the access node 800 may be or act as a “Roadside Unit.” The term “Roadside Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 includes a method for performing wireless communication by performing operations comprising: receiving information indicating configured grant (CG) occasions for communication of information; selecting a set of one or more of the CG occasions for communicating information; determining that a CG occasion of the set of one or more CG occasions overlaps with a scheduled measurement occasion; determining whether the scheduled measurement occasion is eligible to be skipped; and when the scheduled measurement occasion is eligible to be skipped, sending an indication, in unused transmission occasion uplink control information (UTO-UCI), that the CG occasion is valid for use by a user equipment (UE), or when the scheduled measurement occasion is not eligible to be skipped, sending an indication, in the UTO-UCI, that the CG occasion is not valid for use by the UE.

Example 2 includes the method of example 1, the method further comprising: determining that the scheduled measurement occasion is not being skipped; and sending an indication that the CG occasion is available for use by another UE that is different than the UE.

Example 3 includes the method of any of examples 1 or 2, wherein sending the indication in UTO-UCI that the CG occasion is valid for use by the UE comprises excluding the CG occasion from consideration, during generation of the UTO-UCI, as being an unused resource.

Example 4 includes the method of any of examples 1 through 3, wherein sending the indication in UTO-UCI that the CG occasion is invalid for use by the UE comprises indicating, in a bitmap of the UTO-UCI, that the CG occasion is not being used by the UE.

Example 5 includes the method of any of examples 1 through 4, the method further comprising: determining that the scheduled measurement occasion is not being skipped; and sending updated UTO-UCI that explicitly indicates that the CG occasion the CG occasion is available for use by a network.

Example 6 includes the method of any of examples 1 through 5, wherein the UTO-UCI that indicates that the CG occasion is valid for use by the UE explicitly indicates that the CG occasion the CG occasion is not available for use by a network, and wherein the operations further comprise: determining that the scheduled measurement occasion is not being skipped; and sending an updated UTO-UCI that indicates that the CG occasion is available for use by the network.

Example 7 includes the method of any of examples 1 through 6, the method further comprising: determining that the scheduled measurement occasion is being skipped; and scheduling a physical uplink shared channel (PUSCH) transmission using the CG occasion of the set of one or more CG occasions overlaps with a scheduled measurement occasion.

Example 8 includes the method of any of examples 1 through 6, the method further comprising: determining that the scheduled measurement occasion is being skipped; and sending the indication in UTO-UCI that the CG occasion is valid for use by the UE by explicitly indicating in the UTO-UCI that the UE is using the CG occasion for a PUSCH transmission.

Example 9 includes the method of any of examples 1 through 8, wherein sending the indication in UTO-UCI that the CG occasion is valid for use by the UE comprises indicating, in a bitmap of the UTO-UCI, that the CG occasion is being used by the UE.

Example 10 includes the method of any of examples 1 through 9, wherein the scheduled measurement occasion comprises a measurement gap.

Example 11 includes the method of any of examples 1 through 10, wherein the scheduled measurement occasion comprises a synchronization signal (SS) or physical broadcast channel (PBCH) block measurement timing configuration (SMTC) window.

Example 12 includes the method of any of examples 1 through 11, wherein determining whether the scheduled measurement occasion is eligible to be skipped comprises determining that downlink control information (DCI) indicating that the scheduled measurement occasion is being skipped is receivable prior to the CG occasion.

Example 13 includes the method of any of examples 1 through 12, wherein selecting the set of one or more of the CG occasions for communicating information comprises determining an amount of buffered data that can be transmitted on available CG occasions for the UE.

Example 14 includes a method for wireless communication, the method comprising: receiving information indicating configured grant (CG) occasions for communication of information; selecting a set of one or more of the CG occasions for communicating information; determining that a CG occasion of the set of one or more CG occasions overlaps with a scheduled measurement occasion; determining that the scheduled measurement occasion is eligible to be skipped; sending an indication, in unused transmission occasion uplink control information (UTO-UCI), that the CG occasion is being used by a user equipment (UE); receiving an indication that the scheduled measurement occasion is not being skipped; and sending updated UTO-UCI that indicates that the CG occasion is not being used by the UE.

Example 15 includes the method of example 14, wherein sending the indication in the UTO-UCI that the that the CG occasion is being used by the UE comprises indicating, in a bitmap of the UTO-UCI, that the CG occasion is being used by the UE.

Example 16 includes the method of any of examples 14 through 15, wherein sending the updated UTO-UCI comprises indicating, in a bitmap of the UTO-UCI, that the CG occasion is not being used by the UE.

Example 17 includes the method of any of examples 14 through 16, wherein the scheduled measurement occasion comprises a synchronization signal (SS) or physical broadcast channel (PBCH) block measurement timing configuration (SMTC) window.

Example 18 includes the method of any of examples 14 through 17, wherein the scheduled measurement occasion comprises a measurement gap.

Example 19 includes the method of any of examples 14 through 18, wherein determining that the scheduled measurement occasion is eligible to be skipped comprises determining that downlink control information (DCI) indicating that the scheduled measurement occasion is being skipped is receivable prior to the CG occasion.

Example 20 includes a method comprising: sending information indicating configured grant (CG) occasions for communication of information; receiving an indication, in unused transmission occasion uplink control information (UTO-UCI), that the CG occasion is valid for use by a user equipment (UE), or receiving an indication, in the UTO-UCI, that the CG occasion is not valid for use by the UE; and when the UTO-UCI, that the CG occasion is not valid for use by the UE, allocating the CG occasion to a different UE.

Example 21 includes a non-transitory computer storage medium encoded with instructions that, when executed by one or more computers, cause the one or more computers to perform the method of any of examples 1 through 20.

Example 22 includes a system comprising one or more processors and one or more storage devices on which are stored instructions that are operable, when executed by the one or more processors, to cause the one or more processors to perform the method of any of examples 1 through 20.

Example 23 includes an apparatus comprising one or more baseband processors configured to perform the method of any of examples 1 through 20.

Example 24 includes processing circuitry comprising one or more processors configured for performing wireless communication by performing the method of any of examples 1 through 20.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. Processing circuitry comprising:
one or more processors configured for performing wireless communication by performing operations comprising:
receiving information indicating configured grant (CG) occasions for communication of information;
selecting a set of one or more of the CG occasions for communicating information;
determining that a CG occasion of the set of one or more CG occasions overlaps with a scheduled measurement occasion;
determining whether the scheduled measurement occasion is eligible to be skipped; and
when the scheduled measurement occasion is eligible to be skipped, sending an indication, in unused transmission occasion uplink control information (UTO-UCI), that the CG occasion is valid for use by a user equipment (UE); or
when the scheduled measurement occasion is not eligible to be skipped, sending an indication, in the UTO-UCI, that the CG occasion is not valid for use by the UE.

2. The processing circuitry of claim 1, the operations further comprising:
determining that the scheduled measurement occasion is not being skipped; and
sending an indication that the CG occasion is available for use by another UE that is different than the UE.

3. The processing circuitry of claim 1, wherein sending the indication in UTO-UCI that the CG occasion is valid for use by the UE comprises excluding the CG occasion from consideration, during generation of the UTO-UCI, as being an unused resource.

4. The processing circuitry of claim 1, wherein sending the indication in UTO-UCI that the CG occasion is invalid for use by the UE comprises indicating, in a bitmap of the UTO-UCI, that the CG occasion is not being used by the UE.

5. The processing circuitry of claim 1, the operations further comprising:
determining that the scheduled measurement occasion is not being skipped; and
sending updated UTO-UCI that explicitly indicates that the CG occasion the CG occasion is available for use by a network.

6. The processing circuitry of claim 1, wherein the UTO-UCI that indicates that the CG occasion is valid for use by the UE explicitly indicates that the CG occasion the CG occasion is not available for use by a network, and wherein the operations further comprise:
determining that the scheduled measurement occasion is not being skipped; and
sending an updated UTO-UCI that indicates that the CG occasion is available for use by the network.

7. The processing circuitry of claim 1, the operations further comprising:
determining that the scheduled measurement occasion is being skipped; and
scheduling a physical uplink shared channel (PUSCH) transmission using the CG occasion of the set of one or more CG occasions overlaps with a scheduled measurement occasion.

8. The processing circuitry of claim 1, the operations further comprising:
determining that the scheduled measurement occasion is being skipped; and
sending the indication in UTO-UCI that the CG occasion is valid for use by the UE by explicitly indicating in the UTO-UCI that the UE is using the CG occasion for a PUSCH transmission.

9. The processing circuitry of claim 1, wherein sending the indication in UTO-UCI that the CG occasion is valid for use by the UE comprises indicating, in a bitmap of the UTO-UCI, that the CG occasion is being used by the UE.

10. The processing circuitry of claim 1, wherein the scheduled measurement occasion comprises a measurement gap.

11. The processing circuitry of claim 1, wherein the scheduled measurement occasion comprises a synchronization signal (SS) or physical broadcast channel (PBCH) block measurement timing configuration (SMTC) window.

12. The processing circuitry of claim 1, wherein determining whether the scheduled measurement occasion is eligible to be skipped comprises determining that downlink control information (DCI) indicating that the scheduled measurement occasion is being skipped is receivable prior to the CG occasion.

13. The processing circuitry of claim 1, wherein selecting the set of one or more of the CG occasions for communicating information comprises determining an amount of buffered data that can be transmitted on available CG occasions for the UE.

14. A method for wireless communication, the method comprising:
receiving information indicating configured grant (CG) occasions for communication of information;
selecting a set of one or more of the CG occasions for communicating information;
determining that a CG occasion of the set of one or more CG occasions overlaps with a scheduled measurement occasion;
determining that the scheduled measurement occasion is eligible to be skipped;
sending an indication, in unused transmission occasion uplink control information (UTO-UCI), that the CG occasion is being used by a user equipment (UE);
receiving an indication that the scheduled measurement occasion is not being skipped; and
sending updated UTO-UCI that indicates that the CG occasion is not being used by the UE.

15. The method of claim 14, wherein sending the indication in the UTO-UCI that the that the CG occasion is being used by the UE comprises indicating, in a bitmap of the UTO-UCI, that the CG occasion is being used by the UE.

16. The method of claim 14, wherein sending the updated UTO-UCI comprises indicating, in a bitmap of the UTO-UCI, that the CG occasion is not being used by the UE.

17. The method of claim 14, wherein the scheduled measurement occasion comprises a synchronization signal (SS) or physical broadcast channel (PBCH) block measurement timing configuration (SMTC) window.

18. The method of claim 14, wherein the scheduled measurement occasion comprises a measurement gap.

19. The method of claim 14, wherein determining that the scheduled measurement occasion is eligible to be skipped comprises determining that downlink control information (DCI) indicating that the scheduled measurement occasion is being skipped is receivable prior to the CG occasion.

20. A system comprising one or more processors and one or more storage devices on which are stored instructions that are operable, when executed by the one or more processors, to cause the one or more processors to perform operations comprising:
sending information indicating configured grant (CG) occasions for communication of information;
receiving an indication, in unused transmission occasion uplink control information (UTO-UCI), that the CG occasion is valid for use by a user equipment (UE), or
receiving an indication, in the UTO-UCI, that the CG occasion is not valid for use by the UE; and
when the UTO-UCI, that the CG occasion is not valid for use by the UE, allocating the CG occasion to a different UE.
